(19) United States
(12) Patent Application Publication
(10) Pub. No.: US 2019/0010364 A1
(43) Pub. Date: Jan. 10, 2019

(54) TRANSFER TAPE WITH SECURITY FEATURES FOR THE SIDE EDGE OF AN ADHESIVE TAPE

(71) Applicant: TESA SE, Norderstedt (DE)

(72) Inventors: Marcel HÄHNEL, Norderstedt (DE); Arne KOOPS, Neu-Lankau (DE)

(21) Appl. No.: 16/064,571

(22) PCT Filed: Dec. 16, 2016
(86) PCT No.: PCT/EP2016/081497

§ 371 Date: Jun. 21, 2018

(30) Foreign Application Priority Data
Dec. 21, 2015 (DE) 10 2015 226 317.7

(51) Int. Cl. C09J 7/38; C09J 175/04; C09J 7/24; C09J 183/04; C09J 121/00; C09J 133/08; C09J 7/40

(52) U.S. Cl. CPC C09J 7/38; C09J 175/04; C09J 7/243; C09J 7/245; C09J 183/04; C09J 121/00; C08K 3/013; C09J 7/401; C09J 2467/005; C09J 2427/005; C09J 2423/045; C09J 2423/105; C09J 133/08

(57) ABSTRACT

The invention relates to a method for attaching security features (8) to an adhesive tape (1), by introducing the security features (8) into a transfer layer (7) and applying the transfer layer (7) to a carrier film (6) to form a transfer tape (9) and pressing an outer side of the transfer layer (7) onto an end face (5) of a roll (4) of the adhesive tape (1) and adhering the transfer layer (7) on the roll end face (5) and peeling the carrier film (6) from the transfer layer (7), with the transfer layer (7) parting from the carrier film (6) and, with it, the security features (8) remaining on a side edge (11) of the adhesive tape (1).

The invention relates to a method for attaching security features to an adhesive tape. The invention also relates to a transfer tape for attaching security features to an adhesive tape.

In the production of pressure sensitive adhesive tapes, webs of a carrier material or liner, here also understood as substrate web, are coated with adhesives, with the materials in web form being present in widths of 200 mm to 2000 mm. After they have been coated, the wide adhesive tape rolls are slit to form adhesive tape rolls of desired working width. As a result of the slitting operation, the pressure sensitive adhesives (PSAs) are exposed at the slit edges of the adhesive tape rolls. The entire end face of the roll of adhesive tape may have adhesive properties, which make it more difficult or even impossible for further processing to take place and also for the product to be employed.

These drawbacks occur especially when the adhesive tape has a coating of PSA that is thick in relation to the carrier material or liner. In the case of these so-called thick-layer products, in particular, it is also often the case that viscoelastic substrate webs with their own adhesive properties are used, and so the entire end face of the roll of adhesive tape is adhesive across virtually the entire cut surface. As a result of the tackiness of the roll end face, contact with other objects causes the roll of adhesive tape to be destroyed or deformed on removal, and means it can no longer be employed for further use. This drawback is particularly pronounced in the case of very narrow rolls of adhesive tape, referred to as narrow rolls.

Furthermore, an exposed and adhesive roll end face is subject to a high risk of soiling, particularly if dirt and dust are present in the immediate environment. For certain applications, the soiled adhesive tapes cannot be used, especially in the case of transparent bonds in the electronics sector. It is known practice to place siliconized or releasing papers or films onto the side faces. These releasing films or papers are diecut to the size of the roll end face, in appropriate shape and size. This, however, is very costly and inconvenient. Furthermore, the siliconized release discs have to be removed again before the roll of adhesive tape is used, and have to be replaced again after service, thus making the utilization of the adhesive tape roll highly inefficient. On automated processing of the roll, the release discs have to be removed, and a suitable holder must be put in place, without the roll undergoing soiling or sticking to other components in the course of unwinding.

Another alternative customary within the industry is the powdering of the roll end faces with individual pigments, such as talc, for example. With this method, however, there is significant soiling of the entire roll of adhesive tape, since the powdering is accomplished via atomization of the pigments. Furthermore, the small pigments “soak” into the adhesive compound, and so the effect subsides significantly after treatment. There are also changes in the optical properties of the adhesive tape, since the light is diffusely refracted at the slit edge. This is a drawback particularly for display bonds with high visual transparency properties.

WO 2008/095653 A1 describes a method for passivating an edge of pressure sensitive adhesive tapes, in which the passivation is accomplished by physical or chemical crosslinking of the PSA on the edge or by the physical or chemical breakdown of those structures in the PSA that are responsible for the adhesive effect. This is achieved by applying a crosslinker to the side edge, with subsequent UV or IR irradiation, electron irradiation, gamma irradiation or plasma treatment. Crosslinkers disclosed include epoxides, amines, isocyanates, peroxides or polyfunctional silanes. A drawback is the relatively awkward and inconvenient structure of the method.

EP 1 373 423 A1 describes a method for deactivating the adhesive layer of the edge face of a roll of adhesive tape, by applying radiation-crosslinkable acrylates, acrylate oligomers and acrylate prepolymers, and carrying out curing with ionizing and electromagnetic radiation.

US 2010/0047530 A1 describes a method for coating the side edges of a roll of adhesive tape, using an indirect application method, in which radiation-curable coating materials or hot-melting polymers are employed.

EP 1 129 791 A2 describes a method for producing anti-adhesive coatings wherein the anti-adhesive layer is applied by low-pressure plasma polymerization to the material in web form, this material in web form being drawn continuously through a plasma zone which hosts a low-pressure plasma. The anti-adhesive coatings, shaped by means of plasma polymerization, are produced in particular for reverse sides of adhesive tape and for release materials.

The methods identified above are of only limited suitability for reducing the tackiness of the end face of a roll of adhesive tape.

Known from DE 10 2015 203 088 A1 is a method for reducing the end face stickiness of a roll of adhesive tape, by producing a transfer tape by applying a transfer layer to a carrier film in a plasma process. The carrier film is pressed with the outside of the transfer layer onto the roll end face, and the transfer layer in this way is adhered to the roll end face, and thereafter the carrier film is peeled off from the transfer layer, thus leaving a part of the transfer layer adhering at the tacky parts of the end face and thus lowering the end face tack. A drawback of the method, however, is the fact that the transfer layer is applied in a plasma process that requires the provision of a plasma generator. Plasma generators are to start with naturally expensive, and in addition the amount of transfer films with transfer layer that can be manufactured per unit time is not very great. Furthermore, the layers applied in a plasma method are subject to high fluctuations in their layer thickness and structural and chemical uniformity.

Not known, furthermore, is the application of security features to an adhesive tape inexpensively by means of a transfer tape.

It is therefore an object of the present invention to provide a method for attaching security features to an adhesive tape that can be carried out inexpensively.

It is also an object of the invention to provide a transfer tape for attaching security features to an adhesive tape.

The object is achieved by a method as specified at the outset, having the features of claim 1, by introducing security features into a transfer layer and applying the transfer layer to a carrier film to form a transfer tape and pressing an outer side of the transfer layer onto an end face of a roll of adhesive tape and adhering the transfer layer on the roll end face and peeling the carrier film from the transfer layer, with the transfer layer parting from the carrier film and, with it, the security features remaining on the side edges of the adhesive tape.

The adhesive tape customarily comprises a substrate web with at least one adhesive web being applied over the full area of one side of the substrate web. The adhesive tape is wound up to form a wide adhesive tape roll. The wide adhesive tape roll is preferably slit into the adhesive tape rolls of desired width. In this operation, tacky end faces are formed at each end of the adhesive tape roll.

A substrate web here refers to a web which consists preferably of plastic such as PE or PET and which on the one hand may be a carrier web which even after the adhesive tape has been adhered to the surface where sticking is to take place, remains on a side of the adhesive tape that faces away from the surface. On the other hand, the substrate web may also be what is called a liner, often also referred to as a release film or release paper. After the adhesive tape has been applied to the surface where bonding is to take place, the liner is preferably peeled off from the adhesive tape again, and so does not remain with the adhesive tape. All that remains on the surface, preferably, is the adhesive web of the adhesive tape. By the peeling of the liner from the adhesive tape it is possible to release a tacky side of the adhesive tape, to which a further surface is then adhered.

By virtue of the method of the invention, accordingly, the security features are not applied over the full area of one free side of an adhesive web of the adhesive tape, but instead are preferably applied exclusively to the narrow side edges of the adhesive tape. In particular, the security features are placed only onto the side edges of the adhesive web of the adhesive tape, by a part of the transfer layer with the security features passing from the transfer tape to the side margins of the adhesive web.

The transfer layer for this purpose preferably comprises at least one coating layer, and the at least one coating layer is applied to a carrier film, and the coating layer forms at least part of the transfer layer; the transfer layer may also comprise further layers, including, in particular, further coating layers. The carrier film and the transfer layer together form the transfer tape, which is produced and stored separately from the adhesive tape roll. The two are preferably brought together only in use. It is also conceivable for the transfer layer with the security features to be applied within the plant itself. An outer side of the transfer layer is in this case pressed onto the tacky end face of the roll. The pressing of the transfer layer onto the roll end face occurs at, favourably, a pressing temperature of less than 250° C.

The transferring of a transfer layer from the carrier film to the roll end face has the advantage, relative to the direct sprayed application of the coating layer to the roll end face, that solvents within the coating material evaporate as early as on the carrier film and therefore, following the transfer, are no longer able to diffuse into the margin of the layer of adhesive on the roll end face. The solvents that do diffuse into the layer of adhesive on the roll end face cause sometimes significant alteration to the adhesive properties at least at the margin of the roll end face.

The roll of adhesive tape, and also the two end faces of the roll of adhesive tape, are produced preferably by cutting off the adhesive tape roll from a wide adhesive tape roll, meaning that the adhesive tape roll is cut off from the board adhesive tape roll, with tacky end faces being formed at the two cut surfaces.

The method of the invention is applied to the roll of adhesive tape cut off from the wide adhesive tape roll. The adhesive tape roll, accordingly, is produced preferably by rolling up an adhesive tape that comprises a substrate web and at least one adhesive web applied to one side of the substrate web, thus forming an alternating layer ply of adhesive web and substrate web when the adhesive tape is wound up.

The material of the carrier film of the transfer tape is preferably selected from the group of PET, PVC, PC, PP and PE. The transfer tape comprises the carrier film and the transfer layer of the invention having the security features introduced into the transfer layer.

The thicknesses of the carrier film based on PET are between 20 to 100 μm, more particularly between 30 and 50 μm, and the thicknesses of the carrier films based on polypropylene are preferably between 25 to 200 μm, more particularly between 40 and 130 μm; carrier films made of monoaxially oriented polypropylene are particularly suitable for producing the passivating tapes of the invention. Monoaxially oriented films are predominantly single-layer films, although in principle multilayer monoaxially oriented films can also be produced. Known predominantly are single-layer, two-layer and three-layer films, although the number of layers selected may also be greater.

The moduli of elasticity achieved in machine direction, measured at 10% elongation according to ASTM D882, are customarily between 1000 and 4000 N/mm², preferably between 1500 and 3000 N/mm².

The thicknesses of the biaxially oriented films based on polypropylene are particularly between 15 and 100 μm, preferably between 20 and 50 μm.

Biaxially oriented films based on polypropylene can be produced by means of blown film extrusion or by means of customary flat film units. Biaxially oriented carrier films are produced in both single-layer and multilayer forms. In the case of the multilayer carrier films, the thickness and composition of the various layers may also be the same here, although different thicknesses and compositions are known.

Particularly preferred for the transfer tapes of the invention are single-layer, biaxially or monoaxially oriented films and multi-layer, biaxial or monoaxial films based on polypropylene, which exhibit a sufficiently strong bond between the layers, since delamination of the layers during the application is a drawback.

Films based on rigid PVC are likewise known and are used by various adhesive tape manufacturers for producing adhesive packaging tapes. Flexible PVC films are likewise suitable for producing adhesive packaging tapes; it is necessary to take account of their inadequate heat resistance of not more than 60° C.

Carrier films based on rigid PVC can be used. The thicknesses of the carrier films are preferably between 30 and 100 μm, more particularly between 35 and 50 μm. The adhesive tapes of the invention are used as packaging tapes for carton closure.

Different degrees of security are distinguished with regard to the security features.

Open security features are intended to be readily accessible to the untrained viewer, allowing him or her easily to verify the authenticity of the product on the basis of certain visible, known signs. Open security features are therefore those which are evident with only minimal aids, if any. Used for this purpose are coloured security elements, especially those with a colour flop effect, changing their colour depending on the angle of illumination and/or of viewing, and holograms, kinegrams, watermarks, security threads or the like. Such security elements are easy to identify (identification level 1).

For the qualified identification of security elements, hidden security features (level 2) are used, which without aids are not visible and are brought to the knowledge only of the qualified viewer, such as, for example, certified dealers or inspectors, customs or other authorities. Such security elements are findable only after instruction, and consist, for example, of added substances which develop UV or IR activity at certain locations on the products under specified conditions, or consist of specifically employed liquid-crystalline materials or taggants, of which the latter are identifiable, for example, via a defined sequence of their layer construction, are present only in a very small concentration and are visible only with certain aids (magnifying equipment).

The highest identification level (level 3) is possessed by forensic features, which are used for product monitoring by the trade mark proprietor and which are not brought to the knowledge of anyone apart from the trade mark proprietor, legal authorities and specialists.

Such security features are findable only with certain technical and information-related provisions, and are intended in particular for use in evidencing the authenticity or forgery of the product before a court, for product monitoring via distribution chains, for discovering black sheep in the production or distribution chain, for discovering product diversion, parallel trading and illegal reimports or the like. Examples of such elements are DNA taggants, smart-label RFID transponders or the like.

As far as the security features used in accordance with the invention are concerned, they may be any of the three levels.

For example, the features in question may comprise IR active dyes or pigments, doped pigments, (micro) taggants, heat-sensitive substances, moisture-sensitive substances, refractive structures, laser-sensitive pigments and dyes, Holospots, interference pigments and/or electrical circuits.

(Micro) taggants are particles on the microscale that are added to a product, usually in very small quantities, in order to be refindable under defined conditions and hence to serve for product identification and/or proof of authenticity of the products. They have specific particle properties which facilitate their findability or assignment. Often they are multilayer particles which can be coded via the colour and/or the sequence of the layers and which as a result can be assigned to particular products, product batches or manufacturers.

The chemical or physical properties of such particles may also form the basis for their refindability.

For instance, U.S. Pat. No. 4,243,734 A discloses the use of polymer flakes, or of flakes of equal shape and size, cut or punched from metal foils, that carry symbols on their surface that can be assigned to manufacturers or owners.

U.S. Pat. No. 6,643,001 as well describes flakes with defined shape and size which can be coded via a pattern applied to their surface and can be employed for identifying products. The flakes may also be covered additionally with fluorescent layers. They consist very largely of liquid-crystalline cholesteric materials, giving them an appearance of changeable colour with the viewing angle (tilt effect or colour flop).

WO 2005/017048 A1 describes flakes for hidden security applications that consist of an individual inorganic dielectric layer and possess a selected shape and/or have a pattern or symbol on their surface. These flakes consist preferably of zinc sulfide. If this material is treated accordingly, it may also fluoresce.

Employed in accordance with the invention are colour pigments or particles which do not absorb in the region of visible light and under normal circumstances are therefore invisible—only on illumination with a lamp of suitable wavelength are the colour pigments excited and undergo characteristic luminescence. In addition to colour pigments excited by IR radiation, it is also possible for UV-active systems to be employed. Examples of systems with UV fluorescence are xanthenes, coumarins, naphthalimides, etc., which in some cases are given in the literature under the generic heading of “organic luminescents” or “optical brighteners”. Also suitable in principle are luminescents which are excited by electron beams, x-rays and the like, and also thermochromic pigments which undergo reversible colour switch on temperature change.

It is possible to use long-afterglow (phosphorescing) or fluorescing pigments which are excited only or predominantly by UV radiation and which emit in the visible region of the spectrum (as an overview, see, for example, Ullmanns Enzyklopadie der technischen Chemie, 4th edition, 1979, Verlag Chemie).

It is additionally possible for effect pigments to be used. Effect pigments are pigments whose optical effect comes about through normal reflection or interference. There are three groups distinguished here:
metallic effect pigments
interference pigments
lustre pigments

Metallic effect pigments, formerly referred to as bronzes, are flake-shaped metallic pigments. The optical effect of these effect pigments derives from the orientation of the flakes parallel to the surface of the surrounding system, at which directed reflection occurs. They are listed in the Colour Index under C.I. Pigment Metal.

Metallic effect pigments are used for producing metal effects in paints, prints, plastics or cosmetics. The greatest economic significance is possessed by aluminium (C.I. Pigment Metal 1, historically silver bronze) and brass (C.I. Pigment Metal 2, gold bronze).

(Pearl) lustre pigments are synthetic substances, embedded in media, that generate gloss, brightness or iridescent colour effects (gloss is understood to be the sensory impression created by more or less directed reflection of light at surfaces; haze-free high gloss is referred to as brightness). The substances in question are all flakes having above-averagely large diameters of up to 200 micrometres. The pigments are highly refracting themselves, but are embedded into materials with a relatively low refractive index. (In the case of the natural template, pearls, more strongly refracting calcium carbonate layers alternate with protein layers with a lower refractive index.)

They interact with light in three ways:
Simple reflection of incident light rays at the smooth surfaces of the individual flakes produces specular gloss.
Usually, however, only part of the incident light is reflected, while another part enters into the transparent pigment. On its pathway, the beam of light strikes further surfaces between systems with different refractive power, such as the underside of the pigment flake, for instance, and the surrounding medium, and/or the top side of the subsequent particle, and can also be reflected from there. This multiple reflection is perceived by the human eye as a gloss which appears to come from the depth.
Colour effects are also developed by interference, if particles are so thin that wave packets reflected at their top side and/or underside are able to become superimposed on one another. The greater the difference between the refractive indices of pigment and embedding medium, and the more planar the surfaces, the more pronounced the optical effect. If the colour-imparting effect derives wholly or predominantly from this phenomenon, therefore, the term “interference pigments” is also used. Occasionally, however, additional absorption plays a part, as in the case of iron oxide-mica pigments, for instance.

Interference pigments can also be used.

The most important representatives from the class of the pearl lustre pigments or interference pigments are the metal oxide-mica pigments. They consist of thin, transparent mica flakes (substrate) encased with defined layers of high-refractive-index metal oxides such as TiO₂ or Fe₂O₃ (layer). Depending on the construction of the pigments, pearl lustre hues of silver white to chromatic, reddish to coppery or golden, are produced.

It is also possible for any desired combinations of the abovementioned security features and/or of the pigments to be incorporated into the transfer layer.

The transfer layer preferably comprises at least one coating layer. The at least one coating layer is favourably applied to the carrier film with a first adhesive force, and the coating layer is pressed onto the roll end face, and a second adhesive force is developed between the coating layer and the adhesive region of the roll end face, the second adhesive force being greater than the first adhesive force. When the transfer layer or the coating layer is pressed onto the roll end face, and when the carrier film is later on peeled off, the at least one coating layer breaks up, therefore releasing in such a way that it may also be referred to as a release coating layer.

A primer layer is preferably applied over the full area of the carrier film, with a third adhesive force between primer layer and coating layer being lower than the second adhesive force between the tacky regions of the roll end face and the coating layer.

Release coatings of the kind optionally applied on the upper film surface, in other words on the film surface opposite to the adhesive, are in widespread use in the adhesive tape industry. An overview of release coating systems based on silicone and their use in the pressure sensitive adhesives sector is found in “silicone release coating” (D. Jones, Y. A. Peters in Handbook of Pressure Sensitive Adhesive Technology, Third Edition, edited by Donatas Satas, Van Reinhold N.Y., pages 652 to 683).

As a result of the use of reverse-side release coatings, an easy, uniform unwind of the adhesive tapes is achieved. Employed in this context in particular are release coatings based on solvent-borne carbamate systems and based on silicone-based systems.

Release coatings based on silicone systems are suitable as release coatings for the adhesive tapes of the invention. Preferred as release coating are UV-curing silicone systems on a 100% basis, although solvent-borne silicone systems can also be used as a release coating for the adhesive tapes of the invention.

The coat weight of the coating layer onto the carrier material is preferably 0.1 to 3 g/m². In a further particularly preferred embodiment, the layer application of the release coating is set at from 0.2 to 1.5 g/m².

In order to achieve very effective anchorage of the first coating layer of the transfer tape of the invention on the carrier film, an adhesion promoter or primer is applied as a first layer on the carrier film. The coating layer is applied to the adhesion promoter.

Solvent-based and water-based adhesion promoters are used as promoters of adhesion between the carrier film and the at least one coating layer or further layers for producing the transfer tapes. Layers with high affinity for carriers or adhesion to carriers based on thermoplastic films are employed for producing transfer tapes. The high affinity to surfaces of carriers based on thermoplastic films governs the property of such components for use as suitable adhesion promoters. Various adhesion promoter systems are known. For use as adhesion promoters for the first release layer of the transfer tape of the invention it is possible, for example, to employ aqueous adhesion promoters based on polyurethanes, polypropylenes with low levels of chlorination, styrene-butadiene copolymers and acrylates. Solvent-borne adhesion promoters as well are suitable for the anchorage of subsequent layers in the case of the adhesive tapes of the invention. These adhesion promoters are used as primers in the adhesive tape industry.

The coat weight of the primer layer onto the carrier film is preferably 0.5 to 12 g/m². In a further preferred embodiment, the layer application of the first adhesion promoter layer is set at from 1.5 to 6 g/m².

In one preferred embodiment of the transfer tape, the adhesion of the primer layer on the polymer film is improved by corona treatment or very particularly by flame pretreatment, since the surfaces particularly of the carrier films based on PE, PP, PET and PVC can be treated by these widely known methods, such as corona or flame treatment. Surface treatments by flame pretreatment are preferred. An overview of the methods for surface treatment is contained for example in the article “Surface pretreatment of plastics for adhesive bonding” (A. Kruse; G. Kruger, A. Baalmann and O. D. Hennemann; J. Adhesion Sci. Technol., Vol. 9, No. 12, pages 1611 to 1621 (1995)).

The outer side of the transfer layer is preferably not tacky, and with particular preference the outer side of the at least one coating layer is not tacky; this enables particularly easy handling of the transfer tape. The outer side of the transfer tape does not need to be tacky, since the roll end face itself is tacky and a sufficient adhesive connection has been made between roll end face and outer side of the transfer layer; this connection, given corresponding adjustment of the strengths of adhesion between transfer layer and roll end face and between transfer layer and carrier film, allows the transfer layer to be broken out along the at least one coating layer or release coating.

It is, however, also conceivable for an adhesive to be applied over the full area, externally, to the coating layer. The adhesive consists of a pressure sensitive adhesive preferably from the group of the acrylates, natural rubber, synthetic rubber, silicone or polyurethane. Particularly strong adhesion of the coating layer to the roll end face is achieved as a result.

The security features are added preferably to the coating layer. It is also possible, additionally, for colour pigments to have been added, so that after the peeling-off of the passivating tape, the tacky regions of the roll end face are still coloured and additionally have the security features. The coloured design of the adhesive tape can be utilized for a multiplicity of applications; on the one hand, by the application of the passivating layer, the tackiness of the roll end face is reduced; on the other hand, the tacky layer of the adhesive tape, unwound again after passivating, retains a coloured design, and does so only along the side edge of the adhesive web of the adhesive tape unwound again from the roll of adhesive tape.

After the passivation, by means of the transfer tape, the adhesive tape is stored and is used later for bonding two component surfaces. For that purpose the adhesive tape is unwound at least a section from the roll of adhesive tape, and is adhered by its thus-exposed one tacky side of the adhesive web to a first component surface, where it is pressed on. Thereafter the substrate web is peeled from the adhesive web, and a second component surface is adhered to the other side of the adhesive web, which is now exposed. The side edges of the adhesive web, however, still have parts of the transfer layer of the transfer tape and hence also have the security features. The security features are readily legible and detectable from the outside, since they are not covered by one of the two bonded component surfaces.

This is an important advantage of the invention, since the security features introduced into the adhesive web of the adhesive tape are not readable, or only very inadequately readable, from the outside in the bonded state. Even in the bonded state, however, the side edge of the adhesive web remains at least in general readily visible, and the security features are therefore readily readable.

The method of the invention therefore allows security features to be applied to an adhesive tape only along the side edges, with the security features not reaching the free side of the adhesive web of the adhesive tape, meaning that the adhesive force of the adhesive tape 1 overall is not lowered. As a result it is possible, after the application of the adhesive tape to a first component surface and the peeled removal of the carrier film and adherence of a second component surface, to produce an adhesive bond between the two components and, in so doing, to achieve a security effect by virtue of the security features exhibited by the adhesive web at the visible and readable side edges.

With regard to the transfer tape, the object is achieved by a transfer tape for attaching security features to adhesive tapes, having the features of claim 11.

The transfer tape here has a carrier film to which at least one transfer layer is applied, and the first adhesive force between transfer layer and carrier film is lower than the second adhesive force between the tacky regions of the roll end face and the transfer layer. Security features have been installed into the transfer layer, such as IR active dyes or pigments, doped pigments, micro taggants, heat-sensitive substances, moisture-sensitive substances, refractive structures, laser-sensitive pigments and dyes, Holospots, interference pigments and/or electrical circuits. The security features may be introduced randomly or with order into the transfer layer.

On one side, additionally, the carrier film preferably has a relief structure, specifically on the side to which the transfer layer is applied, and so the transfer layer takes on a negative of the relief structure. The relief structure may favourably extend over the entire extent of the side of the carrier film. Through application of the transfer tape to the roll end face, and through subsequent peeled removal of the carrier film of the transfer tape from the roll end face, parts of the transfer layer remain on the tacky regions of the roll end face, and these transfer layer parts take on the negative of the relief structure and hence have an individual recognition value.

The transfer layer preferably comprises at least one coating layer, preferably two or more coating layers; the release of the transfer layer may be between the coating layers or within one of the coating layers. Also conceivable are combinations of the release behaviour of the two aforesaid release behaviours. The coating layer is preferably from the group of the aqueous or solvent-borne or radiation-crosslinking coating materials. A layer of pressure sensitive adhesive may have been applied over the full area to the coating layer, in which case the pressure sensitive adhesive is based favourably on natural rubber, synthetic rubber or polyurethane.

The invention is described in reference to an exemplary embodiment. Here:

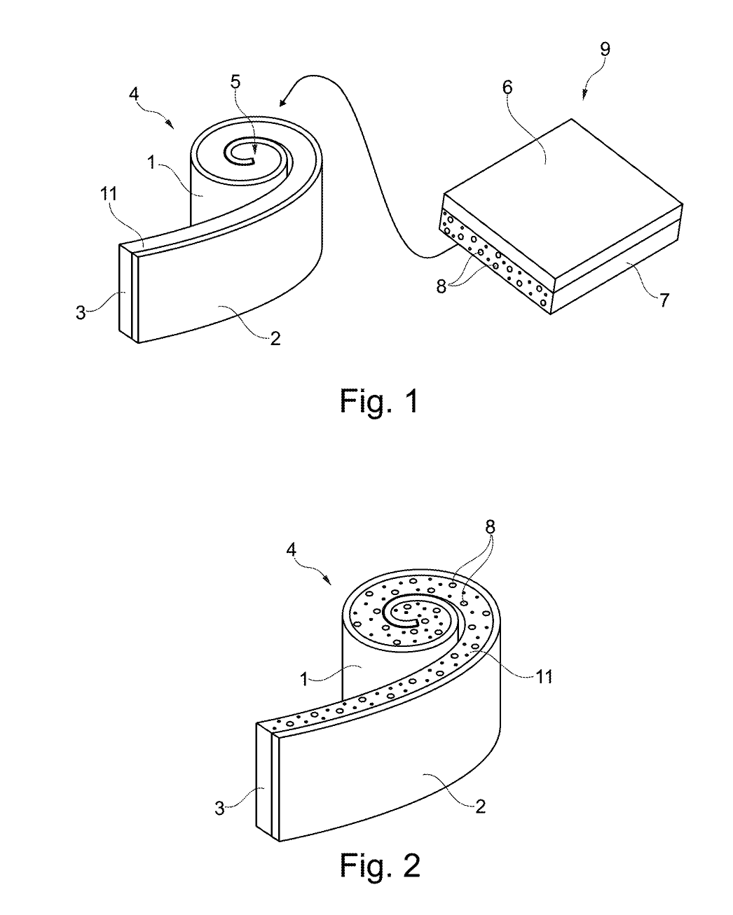

FIG. 1 shows a roll of adhesive tape with end face and also the transfer tape of the invention,

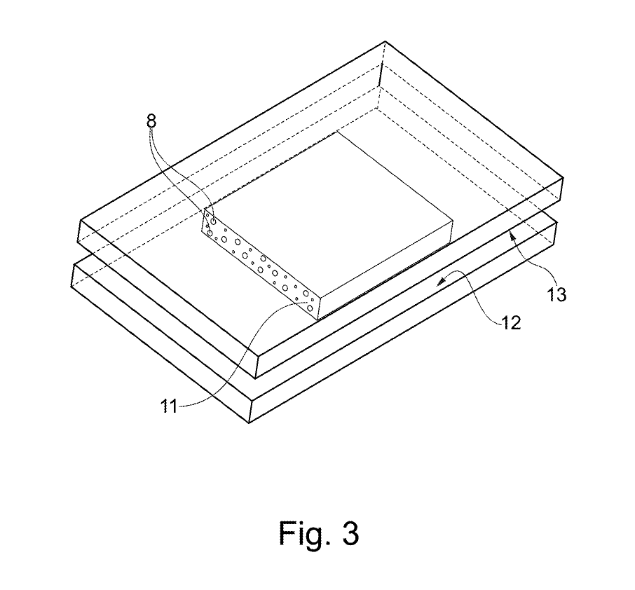

FIG. 2 shows a roll of adhesive tape with end face after transfer of part of the transfer layer of the transfer tape to the roll end face,

FIG. 3 shows the adhesive tape prepared in FIG. 2, after use thereof for bonding two component surfaces together.

FIG. 1 shows an adhesive tape 1 having a substrate web 2 and an adhesive web 3. The adhesive tape 1 is wound up to form an adhesive tape roll 4. The adhesive web 3 and the substrate web 2 are disposed in alternation along a radius of a roll end face 5. The substrate web 2 is not adhesive; the adhesive web 3 is adhesive. FIG. 1 also shows a short transfer tape 9 of the invention, having a carrier film 6 and having a transfer layer into which security features 8, here in the form of fluorescent pigments, have been introduced. The transfer layer consists of a coating layer 7. The transfer tape 9 here comprises the carrier film 6, to which the coating layer 7 has been applied, consisting of Tesa® 64007, a UV curing coating system applied by means of flexographic printing. The coating layer 7 is anchored on the carrier film 6 with a first adhesive force. After the pressing (not shown) of the transfer tape 9 with the coating layer 7 onto the roll end face 5, as represented by the arrow in FIG. 1, and after subsequent peeled removal of the carrier film 6 from the roll end face 5, parts of the coating layer 7 with the security features 8 remain at least on the tacky regions of the roll end face 5, corresponding to the side edges 11 of the adhesive web 3 of the roll end face 5, as shown in FIG. 2. Side edges of the substrate web 2 are free from the coating layer 7. A second adhesive force, between the adhesive web 3 of the roll end face 5 and the coating layer 7 pressed onto the roll end face 5, is greater than the first adhesive force referred to above, and so, by peeled removal of the carrier film 6, the coating layer 7 breaks up and remains adhering partly on the roll end face 5, while the other part of the coating layer 7, pressed onto the roll end face 5 along the substrate web 2, is detached again with the carrier film 6.

Directly after being pressed onto the roll end face 5, the transfer tape 9 can be peeled off again, but it is also possible for it to remain on the roll end face 5 initially, for storage or the like, and to be peeled off only at a later point in time. In that case the transfer tape 9 may be peeled off only a number of hours or even days later. On the one hand, storage may be facilitated by the transfer tape 9 remaining on the roll end face 5; on the other hand, at least with certain varieties of the coating layers 7, an improved adhesion may be developed between the roll end face 5 and the coating layer 7.

The carrier film 6 of the transfer tape 9 is peeled off, and either the whole or substantially the whole coating layer 7 may remain on the roll end face 5, so that only—or essentially only—the carrier film 6 is removed by peeling.

An alternative option is for only part of the coating layer 7 to remain on the roll end face 5. For this purpose, the first adhesive force, between the carrier film 6 and the coating layer 7, is lower than the second adhesive force, between the tacky regions of the roll end face, i.e. side edges 11 of the adhesive web 3 and the coating layer 7.

The roll 4 of adhesive tape shown in FIG. 2 is passivated for storage. The tacky side edges 11 of the adhesive web 3 are passivated by the applied parts of the coating layer 7. The passivated roll 4 of adhesive tape can be used further in accordance with FIG. 3.

FIG. 3 shows schematically a use of the adhesive tape 1 in FIG. 2. For this purpose, a section of the adhesive tape 1 is unwound and is cut off from the roll 4 of adhesive tape, and a first free side of the adhesive web 3 is pressed onto a first component surface 12. The substrate web 2 is then peeled off from the adhesive web 3, and a second component surface 13 is pressed onto the second free side of the adhesive web 3, formed as a result of the peeled removal, in accordance with FIG. 3. The free outer sides of the adhesive web 3 are free from the coating layer 7 and from the security features 8. The coating layer 7 and the security features 8 are found only on the roll end face 5 and, after the use of the adhesive tape 1, on the side edges 11 of the adhesive tape 1 removed by cutting. Advantageously, however, the security features 8 are still readily recognizable from the outside, between the component surfaces 12 and 13, and are not hidden by the component surfaces 12 and 13, and in the case of electronic circuits can be easily read out.

### LIST OF REFERENCE NUMERALS

1 adhesive tape
2 substrate web
3 adhesive web
4 roll of adhesive tape
5 roll end face
6 carrier film
7 coating layer
8 security feature
9 transfer tape
11 side edges
12 first component surface
13 second component surface

1. A method for attaching security features to an adhesive tape, comprising:
introducing the security features into a transfer layer, and
applying the transfer layer to a carrier film to form a transfer tape, and
pressing an outer side of the transfer layer onto an end face of a roll of the adhesive tape, and
adhering the transfer layer on the roll end face, and
peeling the carrier film from the transfer layer, with the transfer layer parting from the carrier film and, with it, the security features remaining on a side edge of the adhesive tape.

2. Method according to claim 1,
wherein the carrier film is selected from a material selected from the group consisting of PET, PVC, PC, PP and PE.

3. Method according to claim 1,
wherein the transfer layer comprises a coating layer and the coating layer is anchored with a first adhesive force on the carrier film and the coating layer is pressed onto the roll end face and, between the coating layer and the tacky regions of the roll end face, a second adhesive force is developed which is greater than the first adhesive force.

4. Method according to claim 1,
wherein, between the coating layer and the carrier film, a primer layer is applied over the full area, and a third adhesive force between the primer layer and the coating layer is lower than the second adhesive force between the tacky regions of the roll end face and the coating layer.

5. Method according to claim 1,
wherein the outer side of the transfer layer consists of a non-tacky coating layer.

6. Method according to claim 1,
wherein an adhesive is applied over the full area externally to the coating layer opposite to the carrier film.

7. Method according to claim 6,
wherein the adhesive is selected from the group of pressure sensitive adhesives based on acrylate, natural rubber, synthetic rubber, silicone, polyurethane or mixtures of these.

8. Method according to claim 1,
wherein the coating layer is pressed onto the roll end face at a pressing temperature of less than 250° C.

9. Method according to claim 1,
wherein the coating layer comprises colour pigments.

10. Method according to claim 1,
wherein the security features are selected from the group consisting of IR active dyes or pigments, doped pigments, micro taggants, heat-sensitive substances, moisture-sensitive substances, refractive structures, laser-sensitive pigments and dyes, Holospots, interference pigments and electrical circuits.

11. Transfer tape for attaching security features to an adhesive tape, comprising
a transfer layer which is applied on a carrier film, and wherein the security features are introduced in the transfer layer, and
a first adhesive force between the transfer layer and the carrier film being lower than a second adhesive force between an end face of a roll of the adhesive tape and the transfer layer.

12. Transfer tape according to claim 11,
wherein the carrier film on one side has a relief structure to which the transfer layer is applied, and the transfer layer adopts a negative of the relief structure.

13. Transfer tape according to claim 11,
wherein the relief structure extends over the entire extent of the side of the carrier film.

14. Transfer tape according to claim 11,
wherein the transfer layer comprises at least one coating layer.

15. Transfer tape according to claim 11,
wherein the at least one coating layer comprises a plurality of different coating layers.

16. Transfer tape according to claim 11,
wherein the at least one coating layer is selected from the group consisting of aqueous, solvent-borne and radiation-crosslinked coating materials.

17. Transfer tape according to claim 11,
wherein a layer of pressure sensitive adhesive is applied over the full area externally on the coating layer, opposite to the transfer film, this layer of adhesive being based on acrylate, natural rubber, synthetic rubber, silicone, polyurethane or mixtures of these.

18. Transfer tape according to claim 11,
wherein the security features comprise IR active dyes or pigments, doped pigments, micro taggants, heat-sensitive substances, moisture-sensitive substances, refractive structures, laser-sensitive pigments and dyes, Holospots, interference pigments and/or electrical circuits.
